(19) United States
(12) Patent Application Publication
(10) Pub. No.: US 2001/0007448 A1
(43) Pub. Date: Jul. 12, 2001

(54) Display apparatus in which blanking data is written during blanking period

(76) Inventors: Reiichi Kobayashi, Tokyo (JP); Toshiyuki Noguchi, Tokyo (JP)

Correspondence Address: Whitham, Curtis & Whitham, Reston International Center, Suite 900, 11800 Sunrise Valley Dr., Reston, VA, 20191, US

(21) Appl. No.: 09/755,165

(22) Filed: Jan. 8, 2001

(30) Foreign Application Priority Data
Jan. 12, 2000 (JP) 3331/2000

(51) Int. Cl. G09G 3/36

(52) U.S. Cl. 345/100

(57) ABSTRACT

A display apparatus includes a display section having pixel rows, and shift registers which drive the pixel rows. The pixel rows are classified into an upper blanking region, a vide display region and a lower blanking region, and a scanning period is classified into a vide display period and a blanking period. The shift registers are grouped into first to third groups such that the first to third groups are independently controlled. The first and third groups are subjected to shifting operations for the upper and lower regions during the blanking period, respectively. The first and third groups drives the display section such that blanking data is written into the upper and lower blanking regions during the blanking period, and the second group drives the display section such that video data is written into the video display region during the vide display period.

### BACKGROUND OF THE INVENTION

1. Field of the Invention

The present invention relates to a display apparatus, and more particularly, to a display apparatus, which can form black blanks at the upper and lower regions of a display screen.

2. Description of the Related Art

In most display apparatuses such as a liquid crystal panel, more pixel rows than scanning lines for a display period are arranged in a column direction. In this case, an inputted video signal for the more scanning lines is supplied to the display apparatus. For example, it is supposed that the video signal has the scanning lines of 1080 in a display period, and the total number of scanning line is 1125 in the display apparatus. In this case, the video signal is processed to have the scanning lines of 1080 in the display period as they are, and is displayed on a liquid crystal panel having 1200 pixel rows in the column direction.

In a liquid crystal panel, in which a complicated driver circuit is manufactured on a panel by use of polysilicon technique, it is known for the driver to open a plurality of gates at a same time, to write black blanks, or performing blanking, as is disclosed in Japanese Patent No. 2820061. Any liquid crystal display, in which digital signal processing is carried out to increase the number of scanning lines, needs to have expensive components such as a frame memory. This inevitably increases the manufacturing cost of the liquid crystal display.

Also, in a liquid crystal panel using amorphous silicon in which no driver (liquid crystal driving circuit) can be formed by use of polysilicon technique, a shift register structure is employed to make it possible to carry out both the upper blanking and the lower blanking with a simple structure. In this shift register structure, a plurality of gates cannot be opened at a same time, as far as they are driven in the known method.

FIG. 1 shows a well known driver in such a shift register structure. A liquid crystal panel 101 has 1200 pixel rows in a vertical direction. Of these pixel rows, 1080 pixel rows function as scanning lines during a display period. FIGS. 2A to 2K are positivelogic timing charts to show that a video signal is displayed by use of 1125 scanning lines. Six vertical drivers 102 to 107 are provided. Each of the drivers 102 to 107 has 200 output ports. The drivers 102 to 107 are shift registers that are driven in response to a vertical drive clock signal VCK. When a vertical start pulse VSP is supplied to the first-stage driver 102 as shown in FIG. 2C, gate pulses GP001 to GP200 as outputs obtained through a shifting operation in response to the clock signal VCK are sequentially supplied from the first-stage driver to the liquid crystal panel 101. The shift registers are connected in cascade, so that the vertical start pulse VSP may drive the next-stage shift register. An output enable signal VOE controls the outputting of the gate pulses GP. A driver having such a register structure cannot open a plurality of gates at the same time.

A state step S1 of FIG. 1 shows a gate pulse 108 to write video data corresponding to the first line of the display period in the liquid crystal panel 101. The enable signal VOE is always active. When the next clock signal VCK is supplied, the gate pulse is shifted downwards in a vertical direction, whereby video data for the next line is written. A state step S2 of FIG. 1 shows a gate pulse 109 to write video data corresponding to the 1080th line, i.e., the last line of the display period, into the liquid crystal panel 101. When a further clock signal VCK is supplied, blanking data is written. The blanking period is composed of 45 lines. The writing operation to the 45 lines is a writing operation of black data. The 1126th line after the writing operation for the 45 lines in the blanking period corresponds to the first line. As shown in a state step S3, gate pulses 111 and 112 are set for the 1126th line and the first line, respectively. Hence, the same video data as the video data corresponding to the first to 1125th lines is written as the 1126th line and the following lines. The liquid crystal panel 101 displays the video data thus written. In FIG. 1, the shaded regions indicate blanking periods during which black video data are written to the liquid crystal panel 101. The white regions in FIG. 1 represent the video display period. In FIG. 1, reference numeral 113 denotes a display pane on which the beginning of the blanking period is displayed as the beginning of a video display period. As can be understood from this method of displaying video data, the writing operation in the blanking periods is possible at the upper and lower ends of the display period. However, video data is inevitably displayed below the lower blanking. The conventional blanking apparatus cannot display black bands at the upper and lower region of the screen.

In conjunction with the above description, an image display system is disclosed in Japanese Laid Open Patent Application (JP-A-Heisei 9-325741). In this reference, rows corresponding to blanking regions are previously selected to set to the active state and blanking data is written to the rows without any shifting operation.

### SUMMARY OF THE INVENTION

Therefore, an object of the present invention is to provide a display apparatus, which can carry out appropriate blanking display by utilizing shift registers.

In order to achieve an aspect of the present invention, a display apparatus includes a display section having pixel rows, and shift registers which drive the pixel rows. The pixel rows are classified into an upper blanking region, a vide display region and a lower blanking region, and a scanning period is classified into a vide display period and a blanking period. The shift registers are grouped into first to third groups such that the first to third groups are independently controlled. The first and third groups are subjected to shifting operations for the upper and lower regions during the blanking period, respectively. The first and third groups drives the display section such that blanking data is written into the upper and lower blanking regions during the blanking period, and the second group drives the display section such that video data is written into the video display region during the vide display period.

Here, the first group may drive the display section such that the blanking data is written into the upper blanking region during a first portion of the blanking period, and the third group may drive the display section such that the blanking data is written into the lower blanking region during a second portion of the blanking period.

In this case, the first group may drive the display section such that the blanking data is written into odd-numbered ones of the pixel rows corresponding to the upper blanking region at a time and then even-numbered ones of the pixel rows corresponding to the upper blanking region at a time during the first portion of the blanking period. Also, the second group may drive the display section such that the blanking data is written into odd-numbered ones of the pixel rows corresponding to the lower blanking region at a time and then even-numbered ones of the pixel rows corresponding to the lower blanking region at a time during the second portion of the blanking period.

In this case, first row selection pulses corresponding to a half of the pixel rows in the upper blanking region may be sequentially supplied to and shifted in the first group and outputted to the display section at a time. Also, second row selection pulses corresponding to a half of the pixel rows in the lower blanking region may be sequentially supplied to and shifted in the third group and outputted to the display section at a time.

In this case, the first row selection pulses may be ejected from the first group after the output to the display section. Also, the second row selection pulses may be ejected from the third group after the output to the display section.

In this case, a third row selection pulse may be supplied to the first group and shifted for the pixel rows in the upper blanking region, during the blanking period, and may be used to drive a start one of the pixel rows in the video display region during the vide display period.

Also, each of the shift registers can sequentially drive corresponding ones of the pixel rows during a horizontal display period.

In another aspect, a blanking method is provided for a display apparatus including a display section with pixel rows, wherein the pixel rows are classified into an upper blanking region, a vide display region and a lower blanking region, and a scanning period is classified into a vide display period and a blanking period. The method is attained by (a) driving the display section such that blanking data is written into the upper blanking region during the blanking period; by (b) driving the display section such that the blanking data is written into the lower blanking region during the blanking period; and by (c) driving the display section such that video data is written into the video display region during the vide display period.

In this case, the step (a) may be attained by (d) driving the display section such that the blanking data is written into the upper blanking region during a first portion of the blanking period. Also, the step (b) may be attained by (e) driving the display section such that the blanking data is written into the lower blanking region during a second portion of the blanking period after the first portion.

Also, the step (a) may be attained by (f) driving the display section such that the blanking data is written into odd-numbered ones of the pixel rows corresponding to the upper blanking region at a time; and by (g) driving the display section such that the blanking data is written into even-numbered ones of the pixel rows corresponding to the upper blanking region at a time during the first portion of the blanking period after the (f) driving. Also, the step (b) may be attained by (h) driving the display section such that the blanking data is written into odd-numbered ones of the pixel rows corresponding to the lower blanking region at a time; and by (i) driving the display section such that the blanking data is written into even-numbered ones of the pixel rows corresponding to the lower blanking region at a time during the second portion of the blanking period after the (h) driving.

In this case, the step (f) may be attained by (j) setting first row selection pulses corresponding to a half of the pixel rows in the upper blanking region; (k) outputting the set first row selection pulses to the display section at a time. Also, the step (g) may be attained by (l) shifting the set first row selection pulses by one pixel row; and by (m) outputting the shifted first row selection pulses to the display section at a time.

In this case, the step (h) may be attained by (n) setting second row selection pulses corresponding to a half of the pixel rows in the lower blanking region; (o) outputting the set first row selection pulses to the display section at a time. Also, the step (i) may be attained by (p) shifting the set second row selection pulses by one pixel row; and by (q) outputting the shifted first row selection pulses to the display section at a time.

Also, the step (f) may be attained by ejecting the first row selection pulses after the (m) outputting. Also, the step (g) may be attained by ejecting the second row selection pulses after the (q) outputting.

Also, the step (f) may be attained by shifting a third row selection pulse for the pixel rows in the upper blanking region during the blanking period, such that the third row selection pulse is used to drive a start one of the pixel rows in the video display region during the vide display period.

Also, the step (c) may be attained by sequentially driving ones of the pixel rows corresponding to a horizontal display period during the horizontal display period.

### BRIEF DESCRIPTION OF THE DRAWINGS

FIG. 1 is diagram showing the structure of a conventional liquid crystal display, and timing charts showing gate pulses of shift registers;

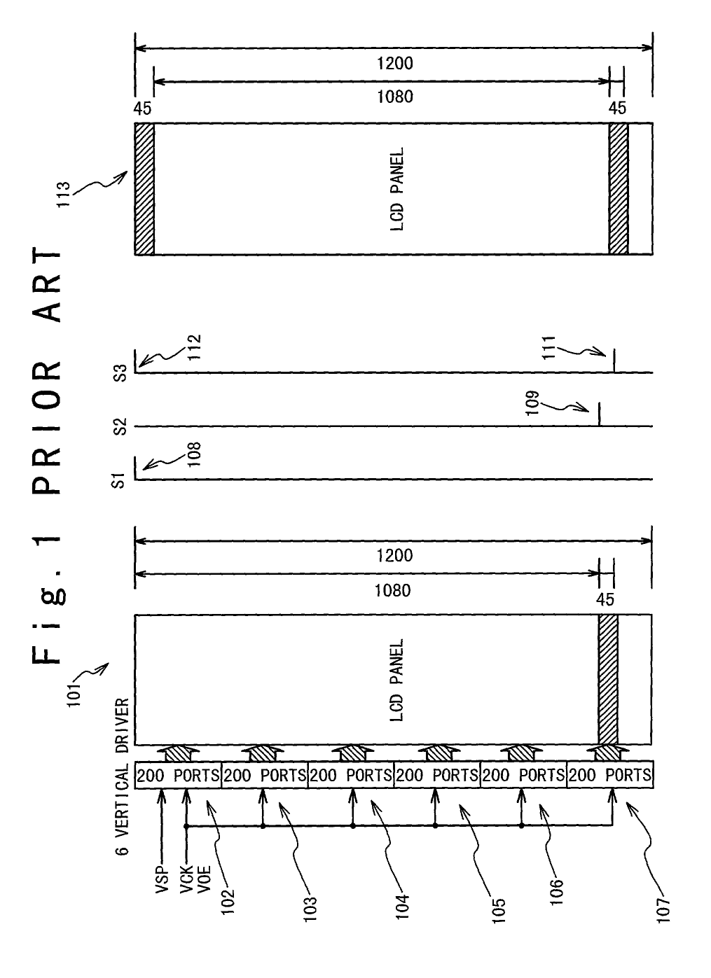

FIGS. 2A to 2K are time charts of the signals which generate the known gate pulses;

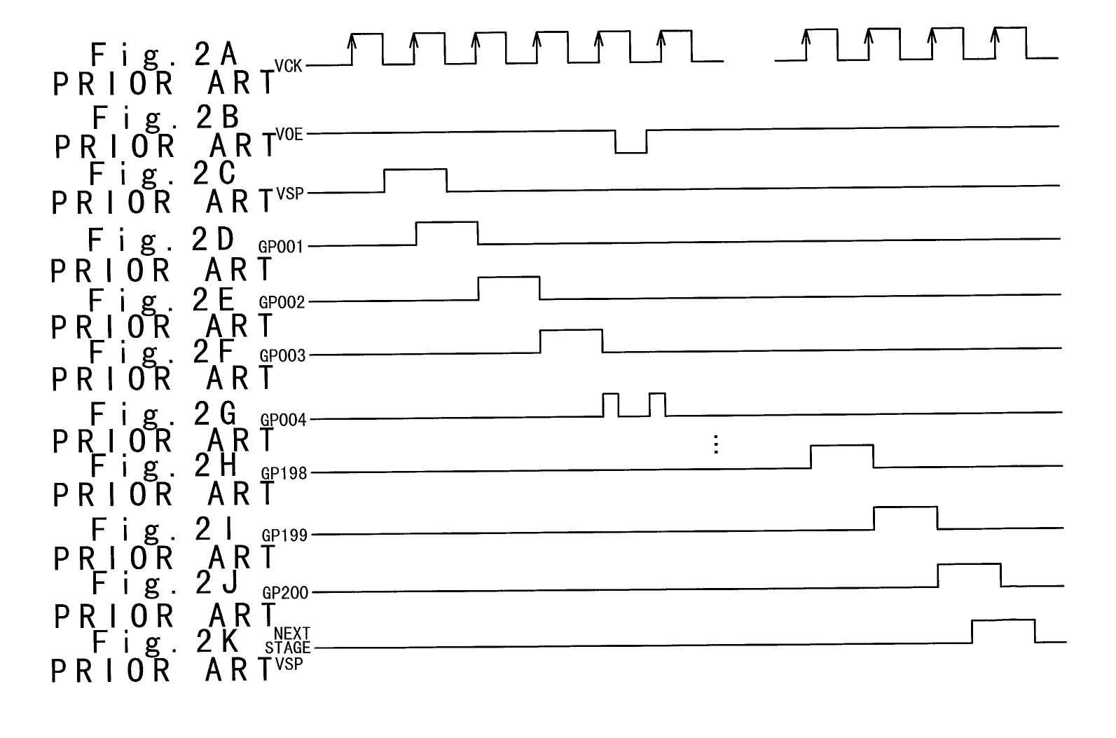

FIG. 3 is a diagram showing the structure of a liquid crystal display apparatus according to a charts of gate pulses in a blanking operation;

FIGS. 4A to 4I are timing charts of three kinds of signals which generate the gate pulses; and

FIGS. 5A to 5H are timing charts of the signals in a second embodiment of the present invention.

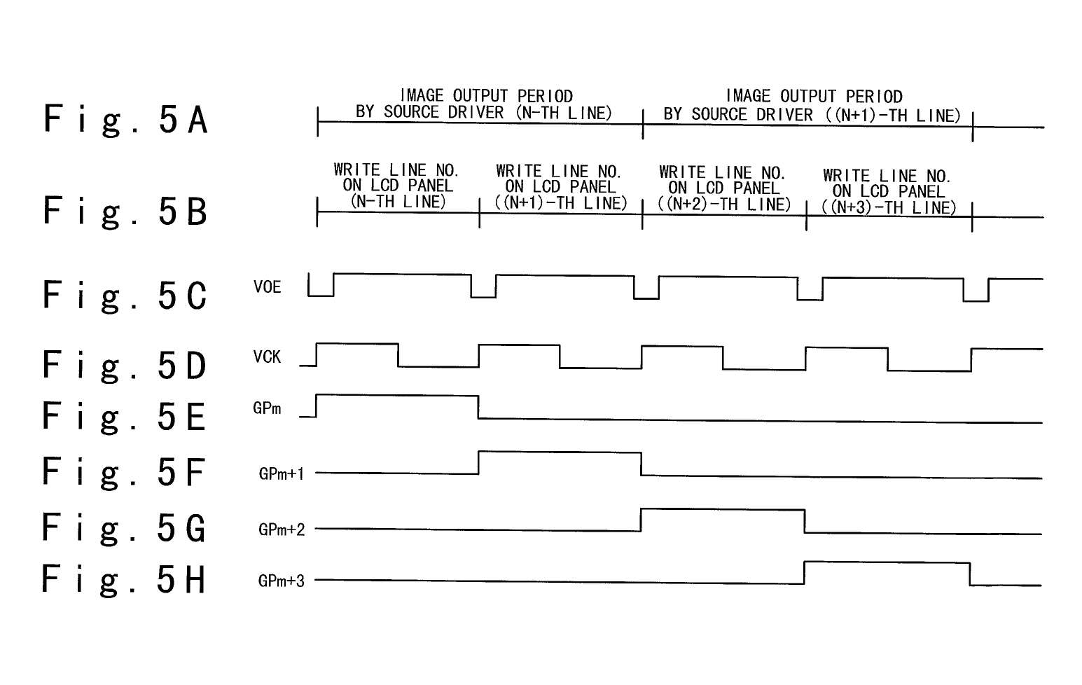

### DESCRIPTION OF THE PREFERRED EMBODIMENTS

Hereinafter, a display apparatus of the present invention will be described below in detail with reference to the attached drawings.

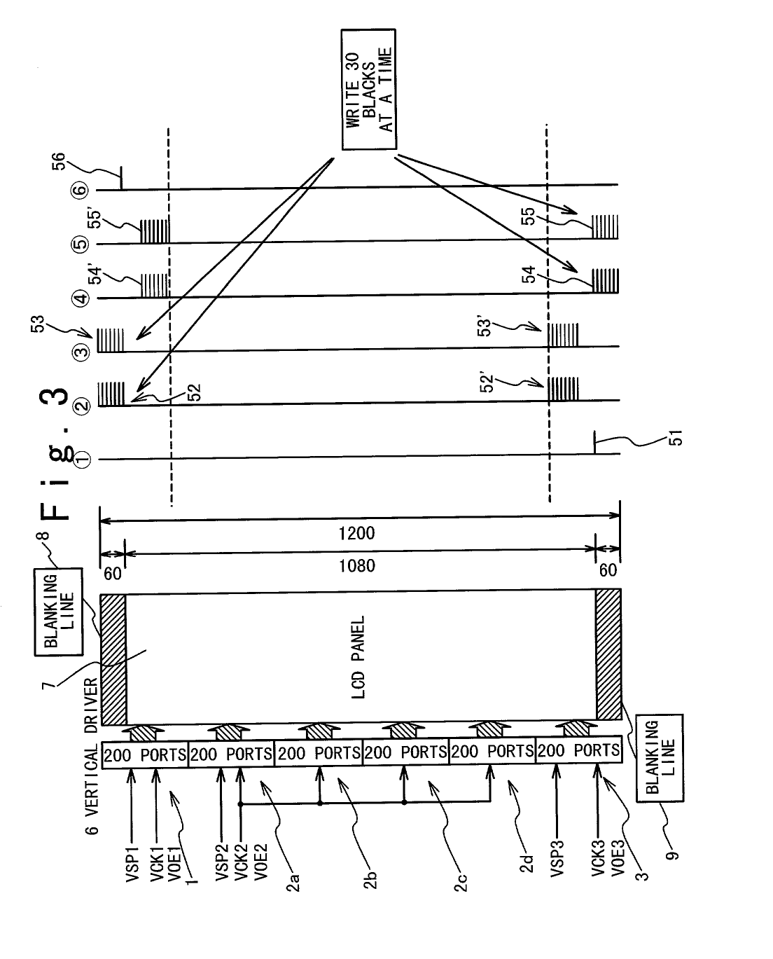

FIG. 3 shows the structure of the display apparatus according to the first embodiment of the present invention. Referring to FIG. 3, the display apparatus is composed of six vertical drivers 1, 2a, 2b, 2c, 2d and 3 and a liquid crystal panel 7. The vertical drivers 1, 2a, 2b, 2c, 2d and 3 are shift registers. The vertical drivers is grouped into a first shift register group 1 of the driver 1, a second shift register group 2 of the drivers 2a to 2d, and a third shift register group 3 of the driver 3.

The first shift register group 1 receives a first clock signal VCK1, a first vertical shift register input signal VSP1 and a first vertical enable signal VOE1 independently from the other drivers. The second shift register groups 2 receive a second clock signal VCK2, and a second vertical enable signal VOE2 in common. However, the second vertical shift register input signal VSP1 is supplied to only the first stage vertical driver 2a of the second vertical shift register group 2. The third shift register group 3 receives a third clock signal VCK3, a third vertical shift register input signal VSP3 and a third vertical enable signal VOE3 independently from the other drivers. The above signals are supplied from a control circuit (not shown).

Each of the first shift register 1, the second shift registers 2, and the third shift register 3 has 200 output ports. Write gate pulses are supplied from the output ports of each shift register to the liquid crystal panel 7. Therefore, the pixel rows of 1200 can be driven. The first gate pulses outputted from the first shift register group 1 are used to write upper blanking data in the upper blanking region 8 during a blanking period by horizontal drivers (not shown). The first gate pulses are also used to write video data during a video display period by the horizontal drivers. The third gate pulses outputted from the third shift register group 3 are used to write lower blanking data in the lower blanking region 9 during the blanking period by the horizontal drivers. The use of the third gate pulses is not limited to this. The third gate pulses are also used to write video data in the display panel 7 during the video display period by the horizontal drivers.

Also, FIG. 3 shows timing charts of the sequence of state steps S1 to S6 in the writing operation of data on the liquid display panel 7.

<State Step S1>

The third shift register group 3 outputs a gate pulse 51 used to write the last one of 1080 scanning lines of the video signal corresponding to the video display period.

<State Step S2>

The first shift register group 1 outputs a group of gate pulses 52 for 30 odd-numbered lines, i.e., the first line, the third line, . . . , the 59th line to the upper blanking region 8 of the liquid crystal panel 7. The gate pulses 52 for the 30 odd-numbered lines are active, whereas the gate pulses for 30 even-numbered lines are not active. Thus, the first shift register group 1 enables the writing operation for the 30 lines or 30 pixel rows at a time. At this time, the third shift register group 3 does not output a group of gate pulses 52′ but carries out a shifting operation.

<State Step S3>

The first shift register group 1 outputs a group of gate pulses 53 for 30 even-numbered lines, i.e., the second line, the fourth line, . . . , the 60th line to the upper blanking region 8 of the liquid crystal panel 7. The gate pulses 53 for the 30 even-numbered lines are active, whereas the gate pulses for 30 odd-numbered lines are not active. Thus, the first shift register group 1 enables the writing operation for the 30 lines or 30 pixel rows at a time. At this time, the third shift register group 3 does not output a group of gate pulses 53′ but carries out a shifting operation.

<State Step S4>

The third shift register group 3 outputs a group of gate pulses 54 for 30 odd-numbered lines, i.e., the 1141st line, the 1143rd line, . . . , the 1199th line to the lower blanking region 9 of the liquid crystal panel 7. The gate pulses 54 for the 30 odd-numbered lines are active, whereas the gate pulses for 30 even-numbered lines are not active. Thus, the third shift register group 3 enables the writing operation for the 30 lines or 30 pixel rows at a time. At this time, the first shift register group 3 does not output a group of gate pulses 54′ but carries out a shifting operation.

<State Step S5>

The third shift register group 3 outputs a group of gate pulses 54 for 30 odd-numbered lines, i.e., the 1142nd line, the 1144th line, . . . , the 1200th line to the lower blanking region 9 of the liquid crystal panel 7. The gate pulses 54 for the 30 even-numbered lines are active, whereas the gate pulses for 30 odd-numbered lines are not active. Thus, the third shift register group 3 enables the writing operation for the 30 lines or 30 pixel rows at a time. At this time, the first shift register group 3 does not output a group of gate pulses 54′ but carries out a shifting operation.

<State Step S6>

The third shift register group 3 outputs a gate pulse 56 corresponding to the 61st scanning line for writing the video signal the first one of the 1080 scanning lines corresponding to the video display period.

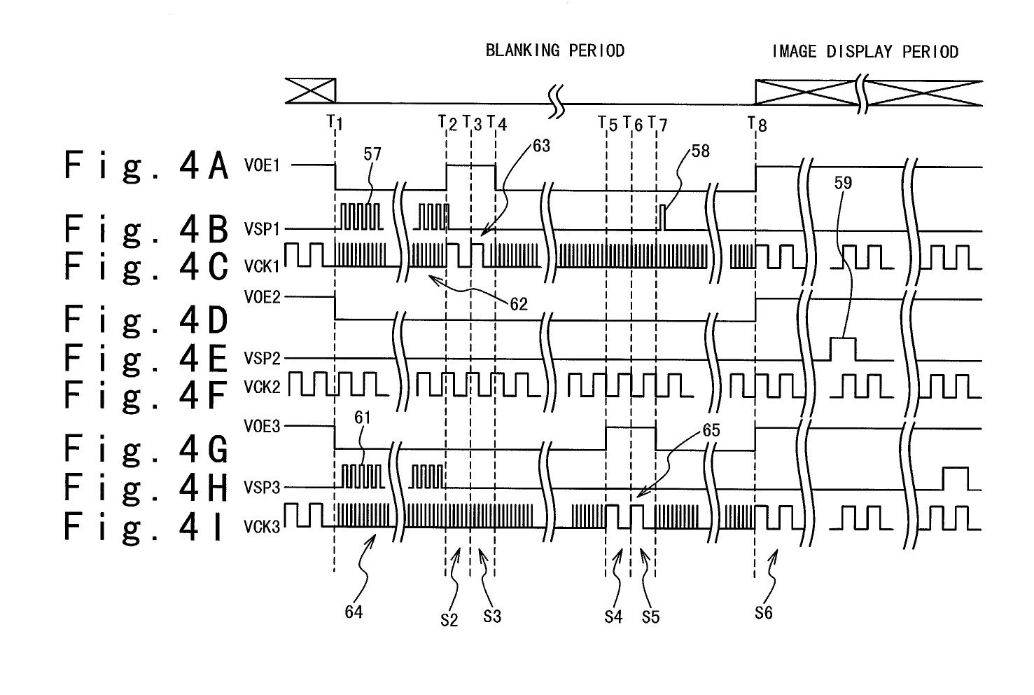

To generate these gate pulses, the signals, namely, the three types of the first clock signal VCK1, first vertical shift register input signal VSP1 and first vertical enable signal VOE1; the second clock signal VCK2, second vertical shift register input signal VSP2 and second vertical enable signal VOE2; and the third clock signal VCK3, third vertical shift register input signal VSP3 and third vertical enable signal VOE3 are supplied to the first shift register group 1, second shift register group 2 and third shift register group 3. FIGS. 4A to 4I shows timings of these nine signals.

The first vertical enable signal VOE1 controls the output of the first shift register group 1. The first vertical enable signal VOE1 is active during the video display period and a part of the blanking period as an upper blanking period. The upper blanking period corresponds to the state steps S2 and S3, both explained above. The first vertical enable signal VOE1 usually remains active during the video display period but may be inactive during that part of the video display period during which no data is held in the internal shift register of the first shift register group 1.

The second vertical enable signal VOE2 controls the outputs of the four shift registers of the second shift register group 2. The second vertical enable signal VOE2 is active during the video display period. The second vertical enable signal VOE2 usually remains active during the video display period but may be inactive during a part of the video display period during which the video data is written by use of the first shift register group 1 or the third shift register group 3.

The third vertical enable signal VOE3 controls the output of the third shift register group 3. The third vertical enable signal VOE3 is active during the video display period and a part of the blanking period as a lower blanking period. The lower blanking period corresponds to the state steps S4 and S5, described above. The third vertical enable signal VOE3 usually remains active during the display period but may be inactive during that part of the display period during which no data is held in the internal shift register of the third shift register group 3.

The first vertical shift register input signal VSP1 is a row selection signal for a shifting operation of the first shift register group 1. The signal VSP1 repeatedly rises to “H” level and falls to “L” level to write 30 lines at the same time, accomplishing the blanking in the state steps S2 and S3. More precisely, the row selection signal 57 corresponding to 30 gate pulses 52 (or 53) is inverted in response to the VCK clock pulse in the first shift register group 1. After the state step S5, a signal 58 of “H” level is supplied to the first shift register group 1, and used to drive one pixel row during the video display period by the first shift register group 1, while the signal 58 is shifted.

The second vertical shift register input signal VSP2 is a row selection signal for a shifting operation of the second shift register group 2. A signal 59 of “H” level is supplied to the second shift register groups 2 during the video display period, such that the second shift register group 2 can output the gate pulse at the next-line timing after the state step S5.

The third vertical shift register input signal VSP3 is a row selection signal for a shifting operation of the third shift register group 3. The signal VSP3 repeatedly rises to “H” level and falls to “L” level to write 30 lines at the same time, accomplishing the blanking in the state steps S4 and S5, such that a signal 61 corresponds to 30 gate pulses 54 (or 55) and are inverted in response to a VCK clock.

The first clock signal VCK1 serves as a lock pulse during every horizontal cycle during the video display period. If no data is held in the first shift register group 1, the supply of the first clock signal VCK1 may be stopped. As the operation goes from the state step S1 to the state step S2 during the blanking period, a high-speed clock signal 62 is supplied to the first shift register group 1 as the signal VCK1 so that 30 gate pulses 52 or 30 gate pulses 53 mentioned above are outputted. In the state steps S2 and S3, the first clock signal VCK1 functions as a clock signal 63 having the same duration as in the video display period so that the blanking data can be written into the display panel 7. The clock signal 63 may be either shorter or longer than the horizontal cycle.

When the high-speed clock signal is supplied to the first shift register group 1 so that the operation may go from the state step S3 to the state step S6, the 30 gate pulses are pulled out from the first shift register group 1. Further, the signal 58 is supplied and shifted for the row selection signal during the video display period.

The second clock signal VCK2 serves as a lock pulse during every horizontal cycle in the video display period. If no data is held in the second shift register group 2, the supply of the second clock signal VCK2 may be stopped. The third clock signal VCK3 functions as a clock pulse during every horizontal cycle in the display period. If no data is held in the third shift register group 3, the supply of the third clock signal VCK3 may be stopped. While the operation goes from the state step S1 to the state step S4 after the video display period, a high-speed clock signal 64 is supplied to the third shift register group 3 so that 30 gate pulses 54 and 30 gate pulses 55, mentioned above are outputted in the lower blanking period. At the state steps S4 and S5, the third clock signal VCK3 functions as a clock signal 65 that has the same period as in the video display period so that the blanking data can be written in the display panel 7. The clock signal 65 may be either shorter or longer than the horizontal cycle. The high-speed clock signal is supplied to the third shift register group 3 so that the 30 gate pulses are pulled out from the third shift register group 3.

That is, 59 pulses are supplied to the first shift register group 1 during a period form T1 to T2. Thus, the row selection signal pulses 57 for 30 odd-numbered pixel rows are outputted at a time. Then, the row selection signal pulses 57 are shifted by one and outputted for 30 even-numbered pixel rows at a time. Thereafter, the signal VCK1 is supplied to the first shift register group for 200 pulses to pull out the row selection signal pulses 57. Subsequently, the signal VSP1 pulse 58 is supplied to the first shift register group and shifted by 60 pulses of the signal VCK1.

Also, 139 pulses are supplied to the third shift register group 1 during a period form T1 to T5. Thus, the row selection signal pulses 61 for 30 odd-numbered pixel rows are outputted at a time. Then, the row selection signal pulses 57 are shifted by one and outputted for 30 even-numbered pixel rows at a time. Thereafter, the signal VCK3 is supplied to the first shift register group for 60 pulses to pull out the row selection signal pulses 61.

A display apparatus according to the second embodiment of the present invention will be described, with reference to FIG. 3. The second embodiment is designed for use in a liquid crystal display which has 1125 scanning lines and which displays videos represented by HDTV signals as interlace signals. During a video outputting period of the source driver, the n-th line is divided into two lines, that is, the m-th write line and the (m+1)-th write line on the liquid-crystal display screen, and two clock signals VCKs and two gate pulses GP are supplied to the liquid crystal panel for the n-th line. Therefore, the display displays an video that is twice as tall as the original video, i.e., is expanded in the vertical direction. In this case, both the upper blanking and the lower blanking can be displayed in a desired manner as has been described above. In consideration of inadequate slew of the drain-line voltage, the vertical enable signals VOEs are not always active and their duration is decreased. Thus, it is prevented that the signals for two lines have different brightnesses. Not only the inadequate slew of the drain-line voltage can be compensated, but also the first write period and the second write period can be rendered equal to each other.

The blanking apparatus and the blanking method according to the invention are advantageous in the following aspects. First, blanking can be achieved as desired, independently of videos, by virtue of the division of the shift register to be used. Second, an apparatus needs not be used, which carries out digital signal processing to increase the number of scanning lines in order to display the blanking. In other words, the blanking can be processed as desired without using an expensive apparatus. Further, even if the number of scanning lines is increased, the frame memory to be used needs not to have its storage capacity increased. Moreover, the blanking can be freely achieved even if each column in the pixel matrix composed of more pixels than the scanning lines represented by an input video signal.

What is claimed is:

1. A display apparatus comprising:
a display section having pixel rows; and
shift registers which drive said pixel rows,
wherein said pixel rows are classified into an upper blanking region, a vide display region and a lower blanking region, and a scanning period is classified into a vide display period and a blanking period,
said shift registers are grouped into first to third groups such that said first to third groups are independently controlled,
wherein said first and third groups are subjected to shifting operations for said upper and lower regions during said blanking period, respectively,
said first and third groups drives said display section such that blanking data is written into said upper and lower blanking regions during said blanking period, and said second group drives said display section such that video data is written into said video display region during said vide display period.

2. The display apparatus according to claim 1, wherein said first group drives said display section such that said blanking data is written into said upper blanking region during a first portion of said blanking period, and
said third group drives said display section such that said blanking data is written into said lower blanking region during a second portion of said blanking period.

3. The display apparatus according to claim 2, wherein said first group drives said display section such that said blanking data is written into odd-numbered ones of said pixel rows corresponding to said upper blanking region at a time and then even-numbered ones of said pixel rows corresponding to said upper blanking region at a time during said first portion of said blanking period, and
said second group drives said display section such that said blanking data is written into odd-numbered ones of said pixel rows corresponding to said lower blanking region at a time and then even-numbered ones of said pixel rows corresponding to said lower blanking region at a time during said second portion of said blanking period.

4. The display apparatus according to claim 3, wherein first row selection pulses corresponding to a half of said pixel rows in said upper blanking region are sequentially supplied to and shifted in said first group and outputted to said display section at a time, and
second row selection pulses corresponding to a half of said pixel rows in said lower blanking region are sequentially supplied to and shifted in said third group and outputted to said display section at a time.

5. The display apparatus according to claim 4, wherein said first row selection pulses are ejected from said first group after the output to said display section, and
said second row selection pulses are ejected from said third group after the output to said display section.

6. The display apparatus according to claim 5, wherein a third row selection pulse is supplied to said first group and shifted for said pixel rows in said upper blanking region, during said blanking period, and is used to drive a start one of said pixel rows in said video display region during said vide display period.

7. The display apparatus according to claim 1, wherein each of said shift registers can sequentially drive corresponding ones of said pixel rows during a horizontal display period.

8. A blanking method in a display apparatus including a display section with pixel rows, wherein said pixel rows are classified into an upper blanking region, a vide display region and a lower blanking region, and a scanning period is classified into a vide display period and a blanking period, said method comprising:
(a) driving said display section such that blanking data is written into said upper blanking region during said blanking period;
(b) driving said display section such that said blanking data is written into said lower blanking region during said blanking period; and
(c) driving said display section such that video data is written into said video display region during said vide display period.

9. The blanking method according to claim 8, wherein said (a) driving includes:
(d) driving said display section such that said blanking data is written into said upper blanking region during a first portion of said blanking period, and
said (b) driving includes:
(e) driving said display section such that said blanking data is written into said lower blanking region during a second portion of said blanking period after said first portion.

10. The blanking method according to claim 8, wherein said (a) driving includes:
(f) driving said display section such that said blanking data is written into odd-numbered ones of said pixel rows corresponding to said upper blanking region at a time; and
(g) driving said display section such that said blanking data is written into even-numbered ones of said pixel rows corresponding to said upper blanking region at a time during said first portion of said blanking period after said (f) driving, and
said (b) driving includes:
(h) driving said display section such that said blanking data is written into odd-numbered ones of said pixel rows corresponding to said lower blanking region at a time; and
(i) driving said display section such that said blanking data is written into even-numbered ones of said pixel rows corresponding to said lower blanking region at a time during said second portion of said blanking period after said (h) driving.

11. The blanking method according to claim 10, wherein said (f) driving includes:
(j) setting first row selection pulses corresponding to a half of said pixel rows in said upper blanking region;
(k) outputting said set first row selection pulses to said display section at a time, and said (g) driving includes:
(l) shifting said set first row selection pulses by one pixel row; and
(m) outputting said shifted first row selection pulses to said display section at a time.

12. The blanking method according to claim 10, wherein said (h) driving includes:
(n) setting second row selection pulses corresponding to a half of said pixel rows in said lower blanking region;
(o) outputting said set first row selection pulses to said display section at a time, and said (i) driving includes:
(p) shifting said set second row selection pulses by one pixel row; and
(q) outputting said shifted first row selection pulses to said display section at a time.

13. The blanking method according to claim 11, wherein said (f) driving includes:
ejecting said first row selection pulses after said (m) outputting.

14. The blanking method according to claim 12, wherein said (g) driving includes:
ejecting said second row selection pulses after said (q) outputting.

15. The blanking method according to claim 11, wherein said (f) driving includes:
shifting a third row selection pulse for said pixel rows in said upper blanking region during said blanking period, such that said third row selection pulse is used to drive a start one of said pixel rows in said video display region during said vide display period.

16. The blanking method according to claim 8, wherein said (c) driving includes:
sequentially driving ones of said pixel rows corresponding to a horizontal display period during the horizontal display period.
